(19) United States
(12) Patent Application Publication
(10) Pub. No.: US 2005/0166198 A1
(43) Pub. Date: Jul. 28, 2005

(54) Distributed policy driven software delivery

(75) Inventors: Anthony F. Gigliotti, Danville, CA (US); Ryan Riley, Meridian, ID (US)

Correspondence Address: Robert E. Krebs;THELEN REID & PRIEST LLP, P.O. Box 640640, San Jose, CA, 95164-0640, US

(73) Assignee: Autonomic Software, Inc., a California corporation

(21) Appl. No.: 10/763,814

(22) Filed: Jan. 22, 2004

(51) Int. Cl. G06F 9/44

(52) U.S. Cl. 717/172

(57) ABSTRACT

A system may scan various reporting services and application manufacturers' websites for recent security upgrades, hot fixes, and service packs. The system may then retrieve these patches and automatically apply these patches on every computer within the corporate network. By inoculating systems before viruses are able to take advantage of their weaknesses, corporations can prevent many of the modern viruses from entering their network and reduce their corporate losses. Furthermore, as a sufficient amount of network and system administrator time is currently utilized on keeping track of security fixes, downloading these patches, and applying them across the corporate network, the implementation of this solution saves money and resources.

### FIELD OF THE INVENTION

The present invention relates to the field of software updates. More specifically, the present invention relates to a solution that allows for distributed policy driven software delivery.

### BACKGROUND OF THE INVENTION

The rise of Internet attacks via computer viruses and other techniques has caused significant financial damage to many corporations. Current anti-virus software operates by comparing incoming files against a list of “offensive” code (e.g., known viruses). If a file looks like one of these offensive codes, then it is deleted and the system protected. There are several major problems with this approach, however, with regard to modern virus attacks.

First, if the virus is new and not in the list of known viruses, the anti-virus solution will not identify it is a virus and therefore it will not keep it from spreading. Second, modern worms such as “code red” and “SQL slammer” do not rely on any of the methods of transmission guarded by most virus protection systems. These new strands of viruses are designed to attack the computer system directly by exploiting faults in the software used by the computer to perform its operations. The viruses are therefore able to crack corporate networks and replicant without the intervention of anti-virus software.

Another critical factor in preventing anti-virus software from protecting modern networks is the speed of modern virus replication and propagation. Whereas years ago it could take years for a virus to disseminate across the United States, modern viruses can spread across the whole world in a matter of minutes.

At the root of the modern virus problem lies system management and maintenance. All network applications are vulnerable to some level of attack, but the software manufacturers work diligently to resolve these errors and release fixes to the problems before they can be exploited by virus producers. In fact, most of the time the application manufacturers have released the fixes to the application that would have prevented a virus from utilizing these holes before the viruses are even released. Unfortunately, due to the complexity of modern networks, most system administrators are unable to keep pace with the increasing number of security patches and hot fixes released from the software manufacturers on every computer in the network.

What is needed is a solution that automates the process of identifying and managing network application security holes.

### BRIEF DESCRIPTION

A system may scan various reporting services and application manufacturers' websites for recent security upgrades, hot fixes, and service packs. The system may then retrieve these patches and automatically apply these patches on every computer within the corporate network. By inoculating systems before viruses are able to take advantage of their weaknesses, corporations can prevent many of the modern viruses from entering their network and reduce their corporate losses. Furthermore, as a sufficient amount of network and system administrator time is currently utilized on keeping track of security fixes, downloading these patches, and applying them across the corporate network, the implementation of this solution saves money and resources.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating an Inoculation Server platform in accordance with an embodiment of the present invention.

FIG. 2 is a diagram illustrating an example of an XML document containing new external update information in accordance with an embodiment of the present invention.

FIG. 3 is a diagram illustrating an outline of external update package tables in accordance with an embodiment of the present invention.

FIGS. 4A and 4B are diagrams illustrating an outline of inventory control tables in accordance with an embodiment of the present invention.

FIG. 5 is a diagram illustrating an outline of distribution control tables in accordance with an embodiment of the present invention.

FIG. 6 is a flow diagram illustrating a method for automatically distributing a software update to a network of devices controlled by an organization in accordance with an embodiment of the present invention.

FIG. 7 is a block diagram illustrating an inoculation server for automatically distributing a software update to a network of devices controlled by an organization in accordance with an embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In an embodiment of the present invention, the system may scan various reporting services and application manufacturers' websites for recent security upgrades, hot fixes, and service packs. The system may then retrieve these patches and automatically apply these patches on every computer within the corporate network. By inoculating systems before viruses are able to take advantage of their weaknesses, corporations can prevent many of the modern viruses from entering their network and reduce their corporate losses. Furthermore, as a sufficient amount of network and system administrator time is currently utilized on keeping track of security fixes, downloading these patches, and applying them across the corporate network, the implementation of this solution saves money and resources.

An Inoculation Server (IS) may be utilized to contact the various security websites, determine what vulnerabilities need to be resolved, download the security patches, and apply them to every computer in the organization. The IS platform may be a highly scalable, distributed solution. A client in the system may be defined as any system that has the client side application installed, which allows the IS to remotely distribute security and other application updates. The security websites may include non-profit organizations like the Internet Security Alliance (ISA), vendor websites, and media technology web sites such as ZDNET, etc.

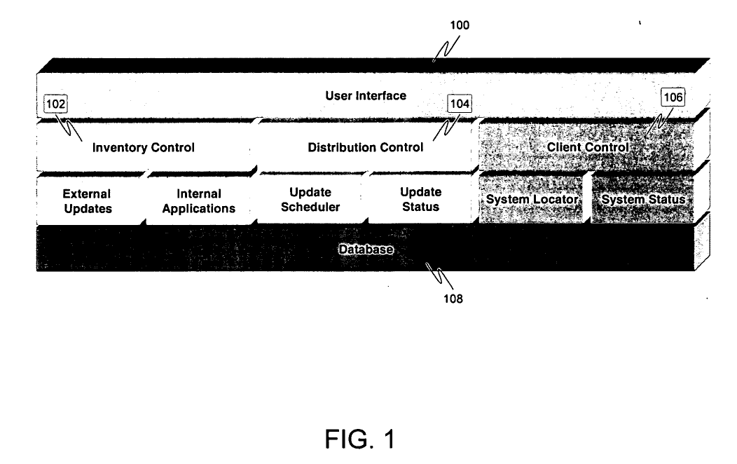

FIG. 1 is a diagram illustrating an Inoculation Server platform in accordance with an embodiment of the present invention. A user interface 100 may be provided to manage the reporting of security updates, client applications, distribution properties, client location and status, as well as to set and manage all other aspects of the IS platform. An inventory control engine 102 may be used to scan for application updates with the Global Update Repository (GUR) and compare them with the client through a client status report.

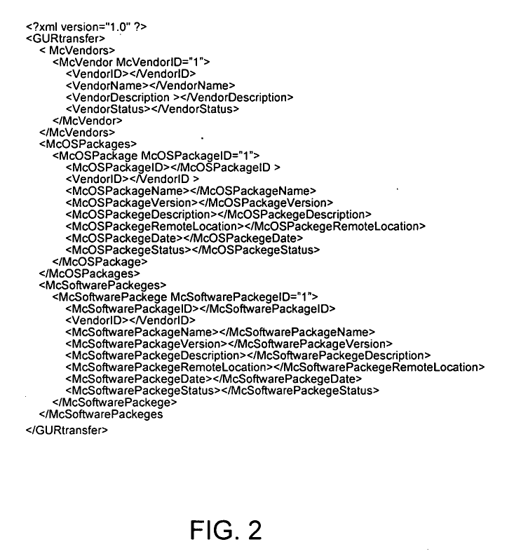

The GUR is a centralized repository that manages all the updates for all operating systems and software packages to be delivered to all the installed inoculation servers. It may utilize standard Internet servers and basic web spiders to mine, retrieve, and archive external update information. In an embodiment of the present invention, the GUR may comprise one or more Windows 2000 servers with .NET and a SQL database. The GUR components may include a user-interface to manage and report on external package updates available within the GUR. This interface may allow user to create accounts and manually view and download update packages. The users may also request a notification, via email, when an update is available. The GUR components may also include a GUR spider, which may scan available online resources for new updates to supported software, and an IS connection engine, which may communicate, via Extensible markup Language (XML), to registered ISs the availability of new software and OS update packages. The communication between the GUR and the IS may be passed through an HTTP GET or POST command. The new external update information may be passed via an XML document. FIG. 2 is a diagram illustrating an example of an XML document containing new external update information in accordance with an embodiment of the present invention.

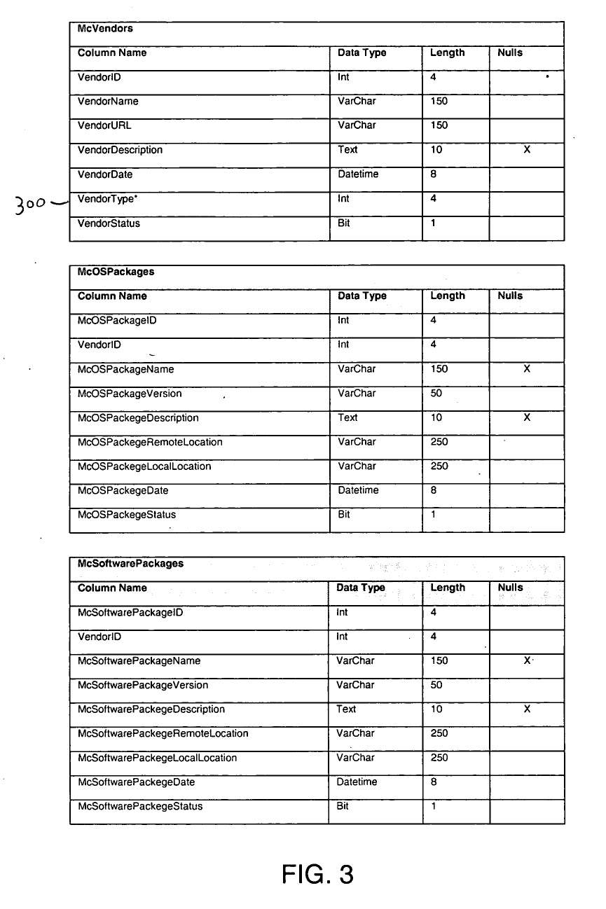

The GUR database may comprise several database tables used to manage user accounts and external update packages available for distributions. The user tables may comprise basic login and contact information, account tracking and history information, as well as account type and states. FIG. 3 is a diagram illustrating an outline of external update package tables in accordance with an embodiment of the present invention. The vendor type field 300 may be a flag used to communicate to the system what type of vendor this is. The vendor types may be automatic download and release, automatic download and manually confirm release, and manually download and confirm.

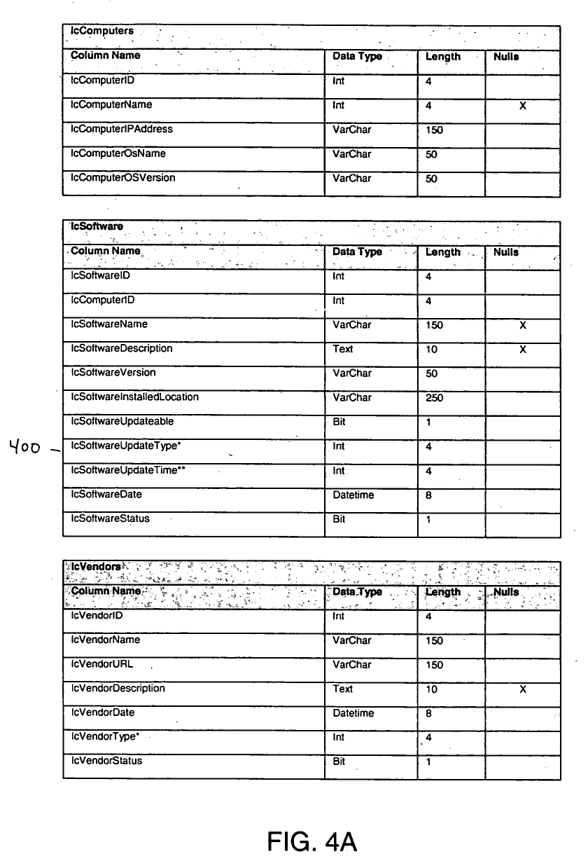

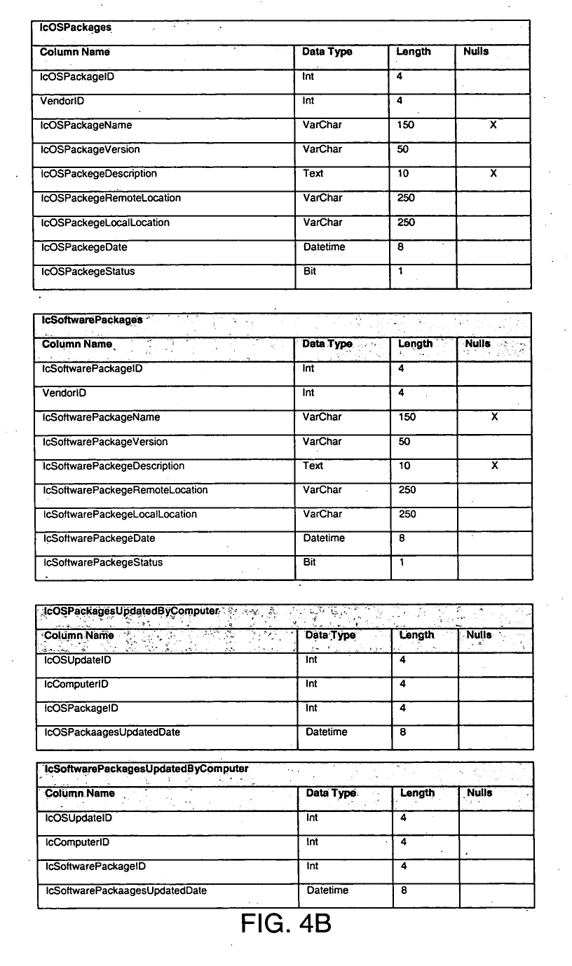

The inventory control engine 102 may have its own SQL database comprised of several database tables used to manage external update package availability for distribution and client application version information. FIGS. 4A and 4B are diagrams illustrating an outline of inventory control tables in accordance with an embodiment of the present invention. The ICSoftwareUpdateType field 400 may be a flag used to communicate to the system what type of application takes. Choices may include automatic immediate, automatic default update time, manual update with notification, and manual update without notification.

A distribution engine 104, notified by the inventory control engine 102, may schedule external package installations and record the status of all client updates. A client control module 106 may have both internal and external components. The external component may be called the Inoculation Client (IC). The IC is a client side application installed on servers or workstations throughout an organization that communicates to the client control module 106. The IC passes to the IS the clients availability on the network and sends a status report to the inventory control module. The IC also queries the database and initiates any jobs that might be available. Once a job is identified, the IC may download the update package and initiate the installation through the use of a command line interface. Once an update is applied, the IC may communicate back to the IS via XML.

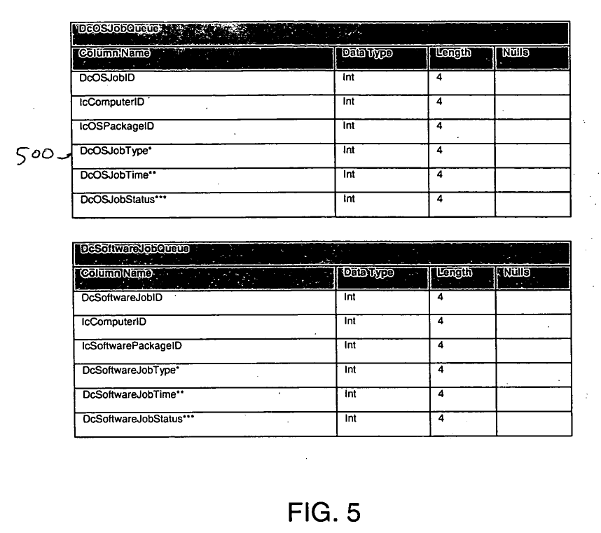

The distribution engine database may comprise several database tables used to manage external update package jobs for distributions and update status information. FIG. 5 is a diagram illustrating an outline of distribution control tables in accordance with an embodiment of the present invention. The DcOSJobType field 500 may be a flag used to communicate to the system what type of updates this application takes. Choices may include automatic immediate, automatic default update time, manual update with notification, and manual update without notification.

A database 108, which may be a Structured Query Language (SQL) database, may provide for the storage of all information for each module within the IS platform. This may comprise all the databases described earlier. The database 108 also, through the use of stored procedures, may manage the comparison of data to assist the inventory control module 102 in identifying which client is ready to have an update applied.

The IS Platform is specifically designed to quickly and effectively apply and implement security updates across an organization's network. It provides key capabilities for detecting when computers are missing software updates, facilitates the distribution of these updates, and provides a complete status report to help ensure that all deliveries were successful.

The process may work as follows. First, the system administrator, in a one-time event, may configure the IS (or proceed with default settings), and perform an initial connection to the GUR. The system administrator may then install the IC on local machines, which then make an initial connection to the IS. The IC, through a regularly scheduled process, may then pass application and system information (e.g., via XML) to the IS. This information may include operating system information and version, installed software applications and versions, and network information.

The inventory control engine may then, through a regularly scheduled process (e.g., once a day), compare all the client information with existing external updates. If an update exists for a client, the inventory control engine may then flag the update package and client for a scheduled update. The update scheduler, triggered by the inventory control engine, may then queue a job for distribution. The IC may then connect to the IS through a regularly scheduled process to check for available distribution jobs. If a job is found, the IC may engage the IS to begin package information.

Once the installation is complete, the IC may notify the IS through the update status module that the installation was complete. The IC may also communicate to the IS if an update package failed to install. In the event of a power failure or other network disturbance, the IC is able to resume an installation process if necessary. Upon completion of the installation, the IC may also notify the inventory control engine of the new software update or new operating system version information, through the client status module. The IS may then validate the process and provide executive and technical reports based on the user defined set of requirements.

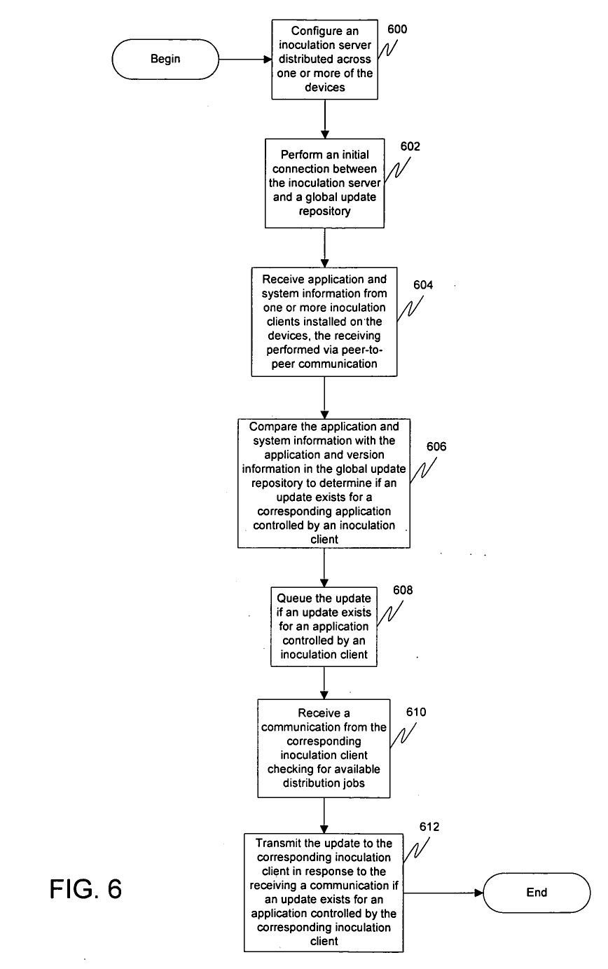

FIG. 6 is a flow diagram illustrating a method for automatically distributing a software update to a network of devices controlled by an organization in accordance with an embodiment of the present invention. At 600, an inoculation server distributed across one or more of the devices may be configured. At 602, an initial connection between the inoculation server and a global update repository may be performed. The global update repository is a centralized repository that manages operating systems and software to be delivered to inoculation servers. It may mine, retrieve, and archive external update information from external security websites using web spiders. The external update information may contain a vendor type, the vendor type being automatic download and release, automatic download and manually confirm release, or manually download and confirm. At 604, application and system information may be received from one or more inoculation clients installed on the devices, the receiving performed via peer-to-peer communication. The application and system information may include operating system information and version, software applications and versions, and network information. It may be received in XML format. At 606, the application and system information may be compared with application and version information in the global update repository to determine if an update exists for a corresponding application controlled by an inoculation client. This may include utilizing an HTTP GET or POST command and may be performed by an inventory control engine. At 608, the update may be queued if an update exists for an application controlled by an inoculation client. This may be performed by a distribution engine. At 610, a communication may be received from the corresponding inoculation client checking for available distribution jobs. At 612, the update may be transmitted to the corresponding inoculation client in response to the receiving a communication if an update exists for an application controlled by the corresponding inoculation client.

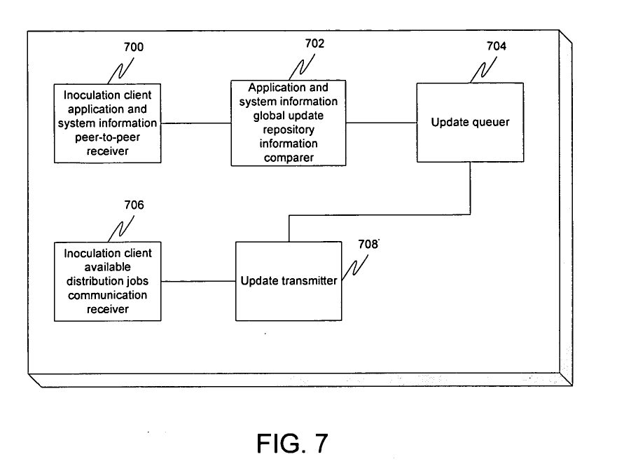

FIG. 7 is a block diagram illustrating an inoculation server for automatically distributing a software update to a network of devices controlled by an organization in accordance with an embodiment of the present invention. The inoculation server may be distributed across one or more of the devices and may first be configured. Then, an initial connection between the inoculation server and a global update repository may be performed. The global update repository is a centralized repository that manages operating systems and software to be delivered to inoculation servers. It may mine, retrieve, and archive external update information from external security websites using web spiders. The external update information may contain a vendor type, the vendor type being automatic download and release, automatic download and manually confirm release, or manually download and confirm. An inoculation client application and system information peer-to-peer receiver 700 may receive application and system information from one or more inoculation clients installed on the devices, the receiving performed via peer-to-peer communication. The application and system information may include operating system information and version, software applications and versions, and network information. It may be received in XML format. An application and system information global update repository information comparer 702 coupled to the inoculation client application and system information peer-to-peer receiver 700 may compare the application and system information with application and version information in the global update repository to determine if an update exists for a corresponding application controlled by an inoculation client. This may include utilizing an HTTP GET or POST command and may be performed by an inventory control engine. An update queuer 704 coupled to the application and system information global update repository information comparer 702 may queue the update if an update exists for an application controlled by an inoculation client. This may be performed by a distribution engine. An inoculation client available distribution jobs communication receiver 706 may receive a communication from the corresponding inoculation client checking for available distribution jobs. An update transmitter 708 coupled to the update queuer 704 and to the inoculation client available distribution jobs communication receiver 706 may transmit the update to the corresponding inoculation client in response to the receiving a communication if an update exists for an application controlled by the corresponding inoculation client.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A method for automatically distributing a software update to a network of devices controlled by an organization, the method comprising:
receiving application and system information from one or more inoculation clients installed on said devices, said receiving performed via peer-to-peer communication;
comparing said application and system information with application and version information in a global update repository to determine if an update exists for a corresponding application controlled by an inoculation client;
queueing said update if an update exists for an application controlled by an inoculation client;
receiving a communication from said corresponding inoculation client checking for available distribution jobs; and
transmitting said update to said corresponding inoculation client in response to said receiving a communication if an update exists for an application controlled by said corresponding inoculation client.

2. The method of claim 1, further comprising:
configuring an inoculation server distributed across one or more of the devices; and
performing an initial connection between said inoculation server and said global update repository.

3. The method of claim 1, wherein said application and system information includes operating system information and version.

4. The method of claim 1, wherein said application and system information includes installed software applications and versions.

5. The method of claim 1, wherein said application and system information includes network information.

6. The method of claim 1, wherein said application and system information is received in Extensible Markup Language (XML) format.

7. The method of claim 1, wherein said queuing said update includes linking said update package and said corresponding application in a database table.

8. The method of claim 1, wherein the global update repository is a centralized repository that manages operating systems and software to be delivered to inoculation servers.

9. The method of claim 8, therein said global update repository mines, retrieves, and archives external update information.

10. The method of claim 9, wherein said external update information is mined and retrieved from external security websites.

11. The method of claim 10, wherein said global update repository uses web spiders.

12. The method of claim 1, wherein said comparing includes utilizing an HTTP GET or POST command.

13. The method of claim 9, wherein said external update information contains a vendor type, said vendor type being automatic download and release, automatic download and manually confirm release, or manually download and confirm.

14. The method of claim 1, wherein said comparing is performed by an inventory control engine.

15. The method of claim 1, wherein said queuing is performed by a distribution engine.

16. An inoculation server for automatically distributing a software update to a network of devices controlled by an organization, the inoculation server distributed among the devices and comprising:
a user interface;
an inventory control engine coupled to said user interface, to one or more inoculation clients, and to a global update repository;
a distribution engine coupled to said user interface and said inventory control engine;
a client control module coupled to said distribution engine and to said one or more inoculation clients; and
a database coupled to said inventory control engine, said distribution engine, and said client control module.

17. An inoculation server for automatically distributing a software update to a network of devices controlled by an organization, the inoculation server distributed among the devices and comprising:
an inoculation client application and system information peer-to-peer receiver;
an application and system information global update repository information comparer coupled to said inoculation client application and system information peer-to-peer receiver;
an update queuer coupled to said application and system information global update repository information comparer;
an inoculation client available distribution jobs communication receiver; and
an update transmitter coupled to said update queuer and to said inoculation client available distribution jobs communication receiver.

18. A system for automatically distributing a software update to a network of devices controlled by an organization, comprising:
one or more inoculation servers distributed among the devices;
one or more inoculation clients distributed among the devices and in peer-to-peer communication with one or more of said one or more inoculation servers; and
a global update repository coupled to said one or more inoculation servers.

19. The system of claim 18, wherein said one or more inoculation servers include:
a user interface;
an inventory control engine coupled to said user interface, to one or more inoculation clients, and to a global update repository;
a distribution engine coupled to said user interface and said inventory control engine;
a client control module coupled to said distribution engine and to said one or more inoculation clients; and
a database coupled to said inventory control engine, said distribution engine, and said client control module.

20. An apparatus for automatically distributing a software update to a network of devices controlled by an organization, the apparatus comprising:
means for receiving application and system information from one or more inoculation clients installed on said devices, said receiving performed via peer-to-peer communication;
means for comparing said application and system information with application and version information in a global update repository to determine if an update exists for a corresponding application controlled by an inoculation client;
means for queueing said update if an update exists for an application controlled by an inoculation client;
means for receiving a communication from said corresponding inoculation client checking for available distribution jobs; and
means for transmitting said update to said corresponding inoculation client in response to said receiving a communication if an update exists for an application controlled by said corresponding inoculation client.

21. The apparatus of claim 20, further comprising:
means for configuring an inoculation server distributed across one or more of the devices; and
means for performing an initial connection between said inoculation server and said global update repository.

22. The apparatus of claim 20, wherein said application and system information includes operating system information and version.

23. The apparatus of claim 20, wherein said application and system information includes installed software applications and versions.

24. The apparatus of claim 20, wherein said application and system information includes network information.

25. The apparatus of claim 20, wherein said application and system information is received in Extensible Markup Language (XML) format.

26. The apparatus of claim 20, wherein said queuing said update includes linking said update package and said corresponding application in a database table.

27. The apparatus of claim 20, wherein the global update repository is a centralized repository that manages operating systems and software to be delivered to inoculation servers.

28. The apparatus of claim 20, therein said global update repository mines, retrieves, and archives external update information.

29. The apparatus of claim 28, wherein said external update information is mined and retrieved from external security websites.

30. The apparatus of claim 29, wherein said global update repository uses web spiders.

31. The apparatus of claim 20, wherein said means for comparing includes means for utilizing an HTTP GET or POST command.

32. The apparatus of claim 28, wherein said external update information contains a vendor type, said vendor type being automatic download and release, automatic download and manually confirm release, or manually download and confirm.

33. The apparatus of claim 20, wherein said means for comparing is an inventory control engine.

34. The apparatus of claim 20, wherein said means for queuing is a distribution engine.

35. A program storage device readable by a machine, tangibly embodying a program of instructions executable by the machine to perform a method for automatically distributing a software update to a network of devices controlled by an organization, the method comprising:
receiving application and system information from one or more inoculation clients installed on said devices, said receiving performed via peer-to-peer communication;
comparing said application and system information with application and version information in a global update repository to determine if an update exists for a corresponding application controlled by an inoculation client;
queueing said update if an update exists for an application controlled by an inoculation client;
receiving a communication from said corresponding inoculation client checking for available distribution jobs; and
transmitting said update to said corresponding inoculation client in response to said receiving a communication if an update exists for an application controlled by said corresponding inoculation client.
